(19) United States
(12) Patent Application Publication
(10) Pub. No.: US 2013/0277328 A1
(43) Pub. Date: Oct. 24, 2013

(54) Container Closure

(71) Applicants: Derek Hindle, Sauvian (FR); Peter Pargen, Zell-Barl (DE)

(72) Inventors: Derek Hindle, Sauvian (FR); Peter Pargen, Zell-Barl (DE)

(73) Assignee: OBRIST CLOSURES SWITZERLAND GMBH, Reinach (CH)

(21) Appl. No.: 13/824,958

(22) PCT Filed: Jul. 11, 2012
(86) PCT No.: PCT/GB2012/000581

§ 371 Date: Jul. 10, 2013

(30) Foreign Application Priority Data
Aug. 3, 2011 (GB) 1113424.4
Aug. 3, 2011 (GB) 1113427.7
Aug. 3, 2011 (GB) 1113428.5
Aug. 3, 2011 (GB) 1113455.8

(51) Int. Cl. B65D 41/62; B29D 99/00; B65D 23/00

(52) U.S. Cl. CPC B65D 41/62; B65D 23/00; B29D 99/0096
USPC 215/200; 215/386; 264/318

(57) ABSTRACT

A moulded closure base includes a sidewall and a top plate. The sidewall has a retention projection having a retention surface for engaging a complementary projection on a container neck. The top plate has one or more access slots through which part of a die extends during moulding to form the retention surface.

The present invention relates generally to the attachment of closures to container necks.

There are many cases in which a container closure must be firmly retained on a container neck. However, the requirements for strong retention and easy application are conflicting. The requirement for firm retention can make initial application of the closure difficult, particularly if there is a preference not to make significant modifications to a container neck, for example to accommodate increased capping forces.

The present invention seeks to address the problems with known systems of the general type know as push-on, press-on, snap-on and the like.

According to an aspect of the present invention there is provided a moulded closure base including a sidewall and a top plate, the sidewall having a retention projection having a retention surface for engaging the complimentary projection on a container neck, the top plate having one or more access slots through which part of a dye extends during moulding to form the retention surface.

The present invention is based upon the principle that if the part of the tooling which forms the retention projection is positioned “above it” then a very sharp top retaining surface can be provided. This represents a significant improvement over conventional moulding techniques in which retention beads are formed by tooling which fits in from underneath the closure so that the closure must be “jumped” or “bumped” off the mould. This technique requires a much smoother bead to allow it to be jumped off the mould and this generally requires a much deeper projection to provide sufficient retention capacity, which in turn leads to higher application forces.

The present invention can therefore be used to provide a sidewall which is complete and by this is meant that no lateral slots or the like need, to be provided in the sidewall for tooling access points (which is known, for example, in the production of tamper-evident bands) and this in turn leads to a stronger sidewall which again will improve the retention capacity of the closure.

The slots in the top plate are the consequence of the tooling which passes “from the top” and into the interior of the base.

The retention surface may be generally straight and/or have straight edges. This can be used to provide the best possible engagement with a corresponding projection on a container neck.

At least part of the retention surface may extend at an angle approximately 90° with respect to the main base axis. For example, the retention surface may extend generally orthogonally from the sidewall. Alternatively or additionally at least part of the retention surface may extend as an angle of less than 90° with respect to the main base axis. The provision of a reverse taper can give an extremely strong retention with a relatively shallow projection which can be used to minimise the application force required.

According to a further aspect of the present invention there is provided a closure base including a sidewall having the retaining projection for engaging a complimentary projection on a container neck, the retaining projection including a generally straight retention surface which extends at an angle of 90° or less with respect to the main base axis.

The base may include a dispensing orifice, for example a centrally positioned aperture for flowable product.

The retention projection may be continuous, for example an annular bead. Alternatively the retention projection may be discontinuous, for example, consisting of a plurality of spaced arcuate sections.

The sidewall may include a tamper-evident band and the retention projection may be formed on the tamper-evident band. The projection could therefore be used to ensure that a band is retained on a neck after is it separated from the remainder of the sidewall.

Alternatively the base may be non-removable. In other words, in normal usage the whole base is difficult or impossible to remove after application.

According to a further aspect of the present invention there is provided a method of forming a closure base comprising the steps of: moulding a body including a sidewall and a top plate; moulding a retention projection on the sidewall; in which the tooling for moulding at least part of the retention projection is introduced through the top plate.

The present invention also provides a container closure comprising or including a base as described herein and such a closure in combination with a container.

The closure may further comprise a lid.

According to a further aspect of the present invention there is provided a non-removable base for providing at least part of a container closure, the base comprising a body part including a side wall, a flexing retention band being provided at one end of the side wall, the band being spaced from the end of the side wall and permanently connected thereto, in which the spacing between the band and side wall provides one or more windows for receiving, in use, a retention projection on a container neck, such that the band can easily pass over a container neck projection and thereafter cannot pass back over the projection so that the base is firmly retained on the neck.

The present invention therefore seeks to provide a closure which can be easily applied to a container neck but thereafter is non-removable i.e. very difficult or impossible to remove under normal circumstances.

By providing the flexing band and the window/s the retention projection on the container neck can be designed to be extremely good at retention. For example, a retention feature in the form of an annular bead with an inclined surface and a very sharp undercut could be used to allow the retention band to flex as it passes over the inclined section and thereafter become engaged underneath the undercut with the bead accommodated in the window/s.

The bead or other retention projection on a container neck may be a complete annulus, or, for example, may be provided in a plurality of sections which then accommodate parts of the base extending between the side wall and the band such as retaining straps, bridges and the like.

The retention band may be formed as a complete annulus. Alternatively the band may comprise a plurality of band sections, which may make it more easy to provide flexing band sections.

The retention band may be adapted to engage under part of the container neck retention projection, such as an undercut. Therefore, the “top” of the retention band abuts against the underside of the neck projection. The section of the band may be reduced towards its end proximal to the side wall. In some embodiments the end is relatively sharp so that a very firm engagement under the neck projection can be achieved.

According to a further aspect of the present invention there is provided a container closure comprising or including a base as described herein. Therefore, the base described herein could be the closure itself or alternatively form a base as part of a closure with other components such as a lid, which may be connected by a hinge or other suitable means to the base.

According to a further aspect of the present invention there is provided a non-removable base for providing at least part of a container closure, the base comprising a sidewall with a foldable retention flap, the flap is movable from a first, unfolded position to a second, folded position in which it is engagable with a container neck retention projection whereby to prevent removal of the closure.

The present invention therefore uses an “upturned” flap principle to engage with a container neck projection subsequently to prevent removal of the closure.

The flap may be provided at an end of the sidewall. Alternatively or additionally a flap may be provided at a point along the length of the sidewall.

The base may include a top plate from which the sidewall depends. In some embodiments the top plate is provided with a dispensing orifice.

The flap may be a continuous annulus. For example a folding band may be provided at the free end of the sidewall. Alternatively the flap may comprise a plurality of flap sections each of which folds and engages under a section of neck retention projection.

Closures of the type formed in accordance with the present invention are not intended to be removed from a container following first application. Therefore, the sidewall may be solid because no slots or the like are required for the formation of frangible bridges.

The present invention also provides a closure comprising or including a base as described herein. For example, the base may be the closure or may form part of a closure with additional components such as a lid that may be formed separately from and connectable to the base or formed integrally therewith and connected, for example, by a hinge.

According to a further aspect of the present invention there is provided a container neck finish comprising a mouth with a foldable rim, the rim being movable from a first, unfolded position to a second, folded position in which it is engagable by a closure whereby to retain the closure on the neck.

This aspect of the present invention is therefore based on the idea that in a folded configuration the neck finish can provide excellent resistance to removal of a closure in which it is engaged.

The foldable rim may be formed by a material thinning. The band of material at the top of the neck finish can then be caused to fold upon application of a closure and to be retained in that folded configuration within the closure.

The rim may include a fold line to facilitate movement from the first to the second position. The folding could therefore be achieved by a hinging movement. Alternatively or additionally, the rim may be rollable between the first and second positions; in other words, the rim is gradually caused to bend and the bend line moves progressively along the rim. Thereafter the flap/rim is effectively locked in the second position and cannot return to the first position.

In the first position the rim may be inclined radially outwards. This means that when the closure is applied it may be more likely to be caused to be bent “downwards” so that it folds down towards the remainder of the neck finish.

The neck finish of the present invention may be provided in combination with a closure. The closure may be configured to cause the movement of the rim from the first to the second position and to include space to accommodate the folded rim adjacent a retention projection so that it is folded into and trapped in/against the closure.

The rim may be configured so as not to fold flat against the mouth in the second position.

The rim may extend from the free end of the mouth. In other words the mouth terminates with the rim.

The present invention also provides a closure as described herein.

The rim may be folded into the closure and for this purpose the closures may have a cavity, recess, groove or the like.

The rim may be jammed in the cavity or otherwise retained and constrained so it cannot unfold if an attempt is made to lift the closure off the neck.

The closure may prevent the rim from moving back to the first position.

The closure may be non-removably engaged with the rim in the second position.

The present invention also provides a container having a neck finish as described herein.

The present invention also provides a container as described herein in combination with a closure as described herein.

The present invention also provides a container having a neck finish as described herein and a container as described herein in combination with the closure as described herein.

Different aspects of the invention may be used separately or together.

Further particular and preferred aspects of the present invention are set out in the accompanying independent and dependent claims. Features of the dependent claims may be combined with the features of the independent claims as appropriate, and in combination other than those explicitly set out in the claims.

The present invention will now be more particularly described, by way of example, with reference to the accompanying drawings, in which:

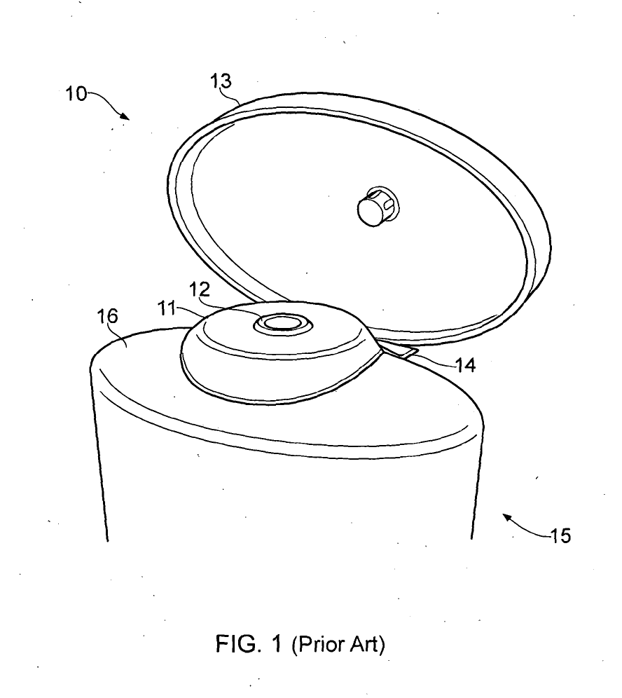

FIG. 1 is a perspective view of a closure to which aspects of the present invention may be applicable;

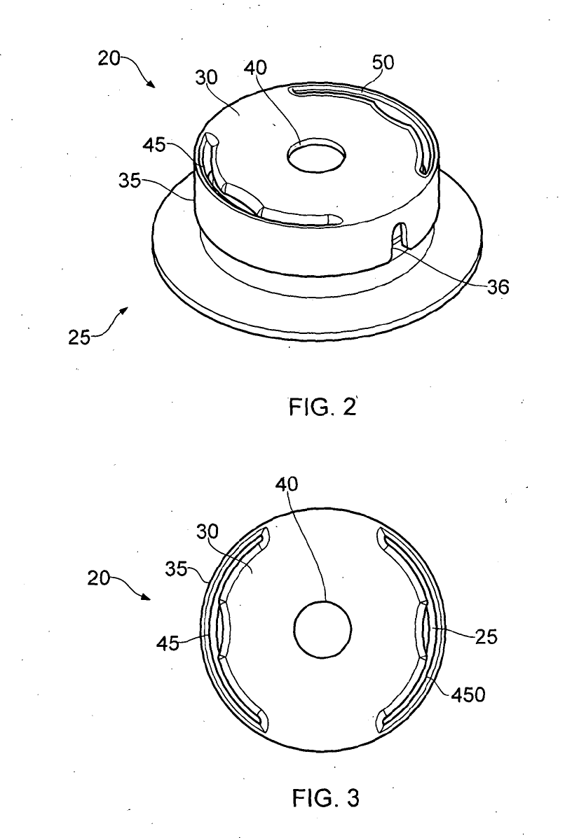

FIG. 2 is a perspective view of a closure base formed according to the present invention;

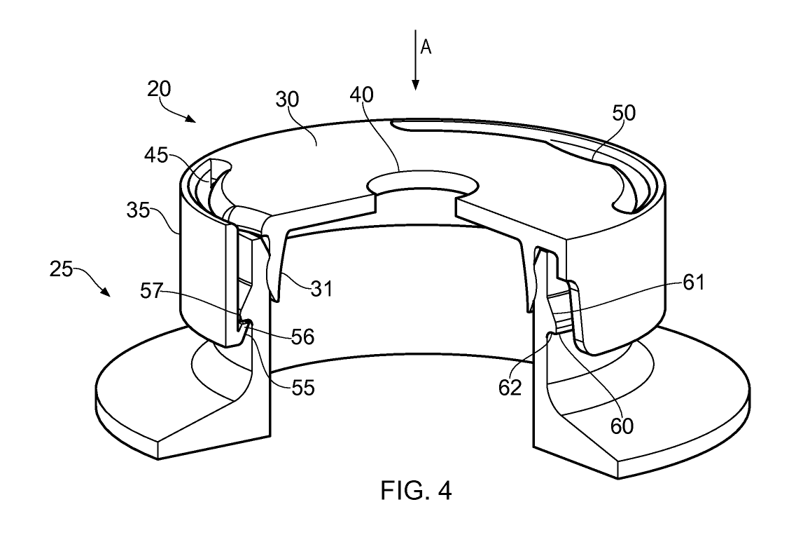

FIG. 3 is a plan view of the closure/container neck of FIG. 2;

FIG. 4 is a sectional perspective view of the closure/container neck of FIGS. 2 and 3;

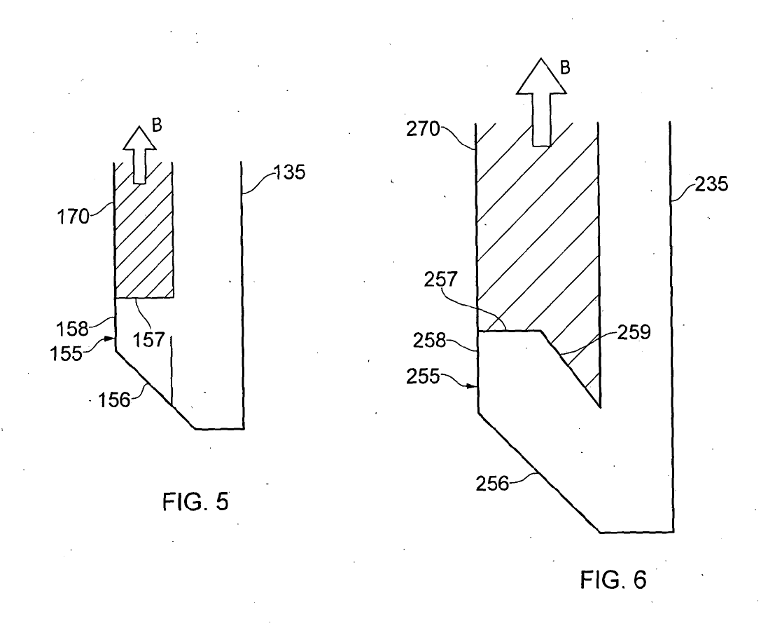

FIG. 5 is a sectional view illustrating a method of moulding according to the present invention;

FIG. 6 is a sectional view illustrating an alternative base structure;

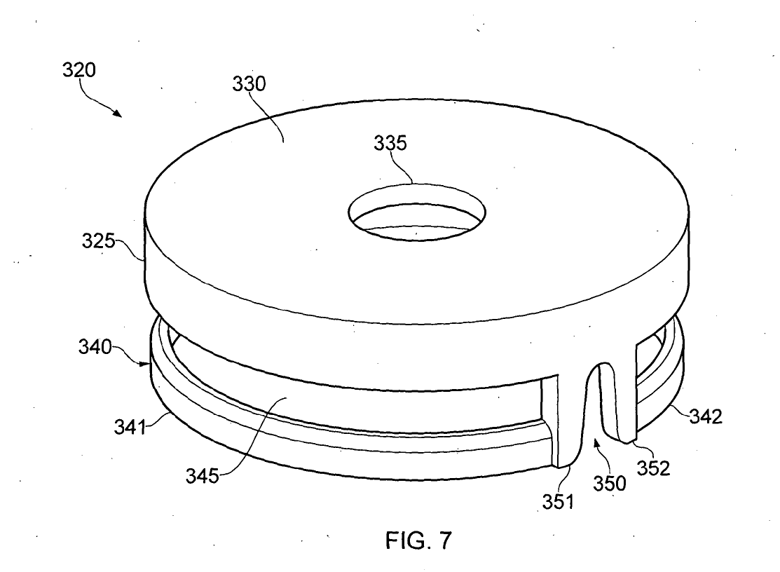

FIG. 7 is a perspective view of a closure formed according to an embodiment of the present invention;

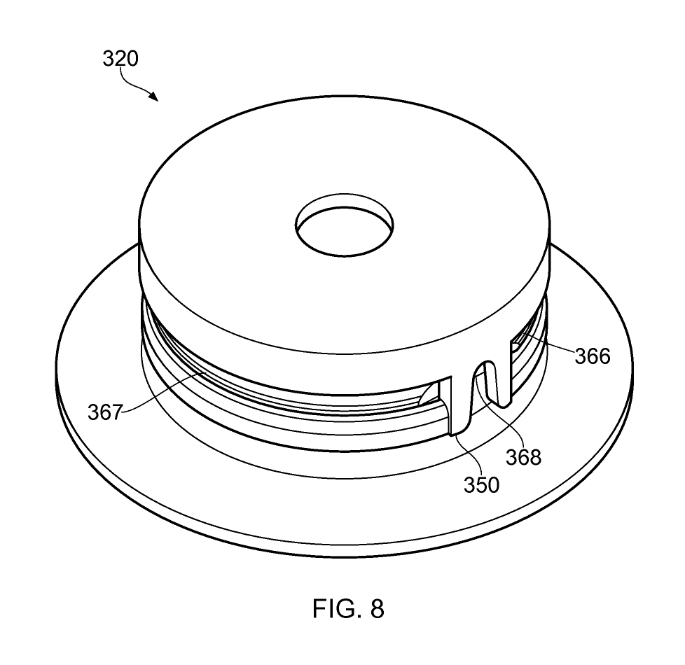

FIG. 8 is a perspective view of the closure of FIG. 7 shown connected to a container neck;

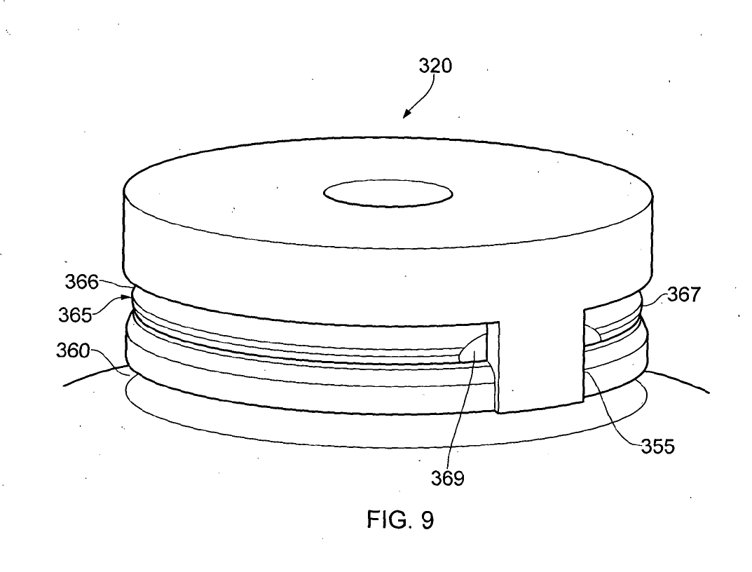

FIG. 9 is an alternative perspective view of the closure of FIG. 8;

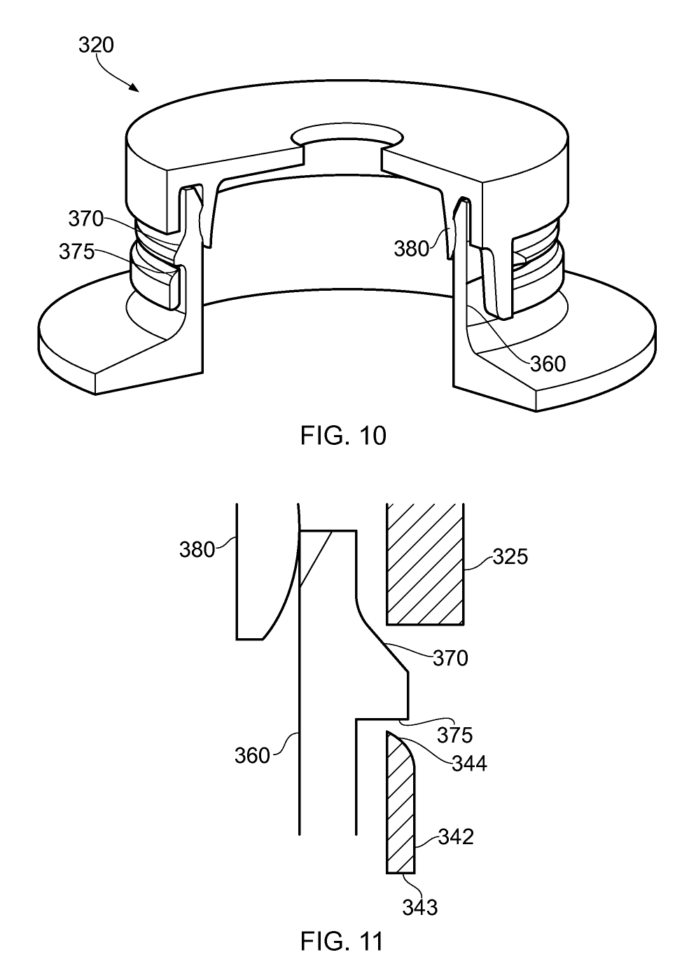

FIG. 10 is a sectional view of the closure/container of FIGS. 8 and 9;

FIG. 11 is a further section of the closure/container of FIG. 10;

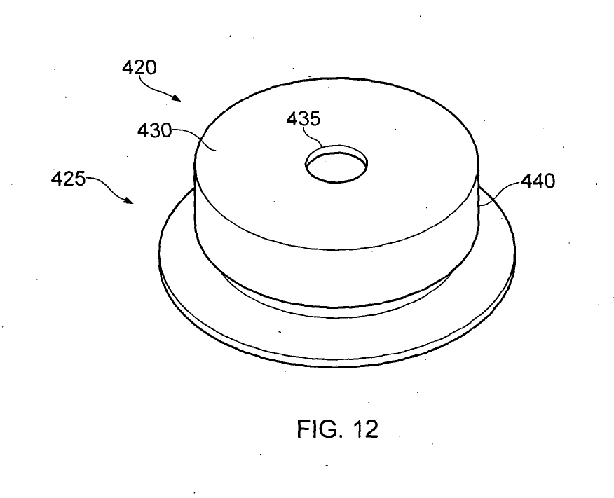

FIG. 12 is a perspective view of a closure base formed according to an aspect of the present invention and shown fitted to a container neck;

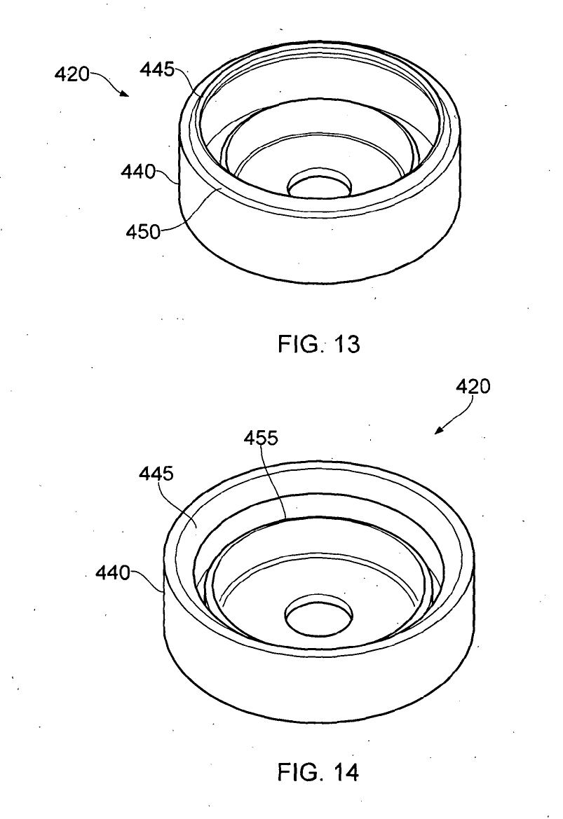

FIG. 13 is a perspective view of the underside of the closure of FIG. 12 with a retention flap shown in a first, unfolded position;

FIG. 14 is a perspective view of the closure of FIG. 13 with the retention flap shown in a second, folded position;

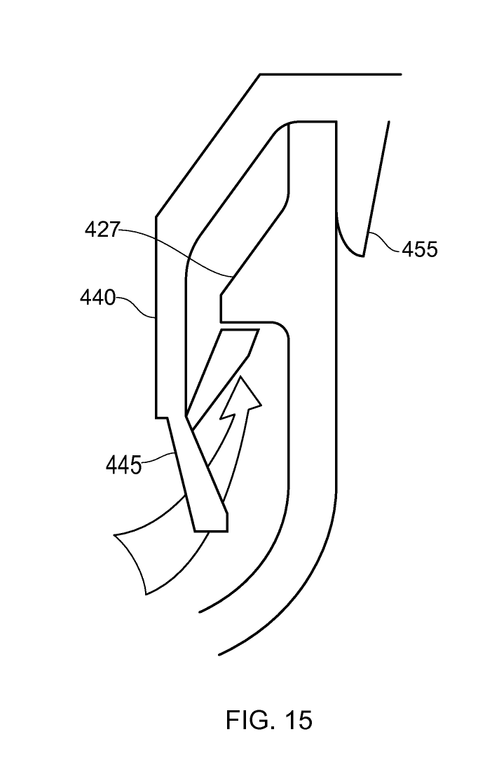

FIG. 15 is a section of the closure of FIGS. 12 to 14 shown fitted to a container neck and illustrating folding of the retention flap;

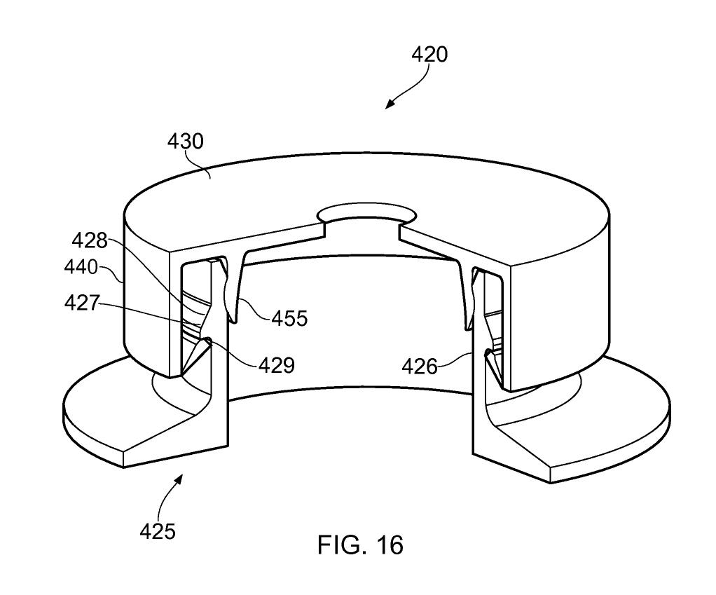

FIG. 16 is a cut-away sectional view of the closure/container neck of FIGS. 12 and 15;

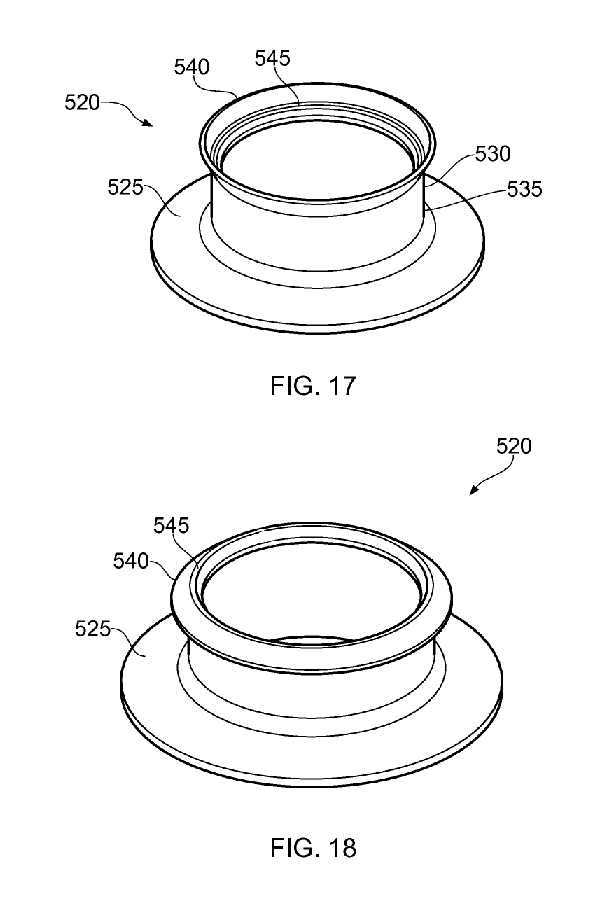

FIG. 17 is a perspective view of a neck finish shown in a first position;

FIG. 18 is a perspective view of the neck finish of FIG. 17 shown in a second position;

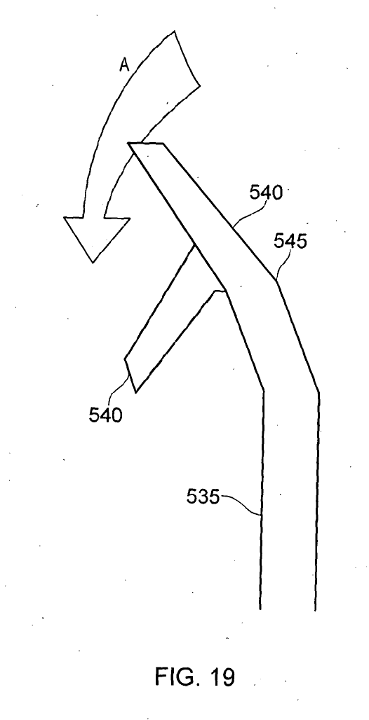

FIG. 19 is a section of the container necks of FIGS. 17 and 18 illustrating the movement between the first and second positions;

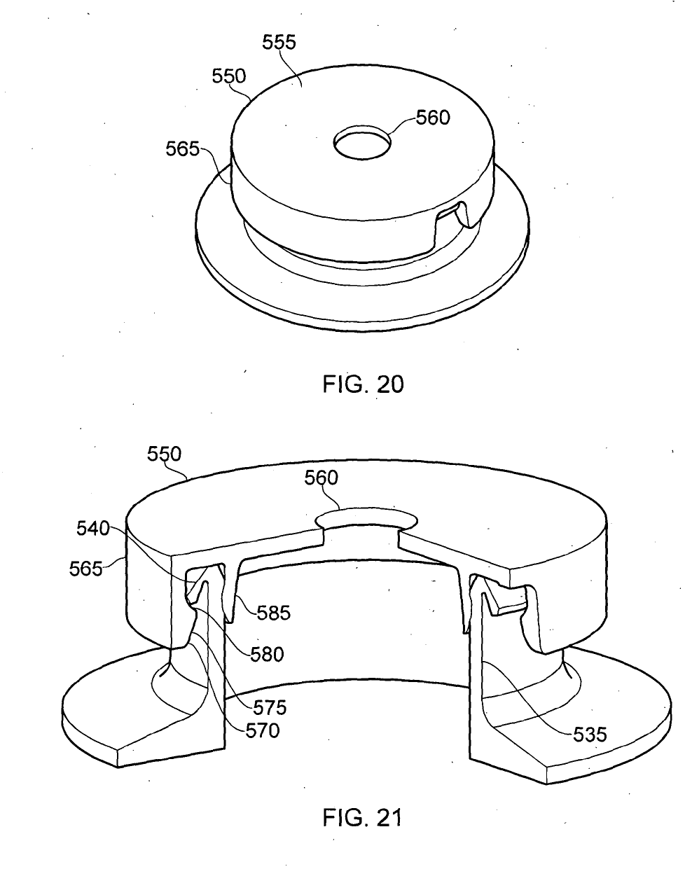

FIG. 20 is a perspective view of a closure base fitted to the neck of FIGS. 17 to 19;

FIG. 21 is a cut away sectional view of the closure/neck of FIG. 20; and

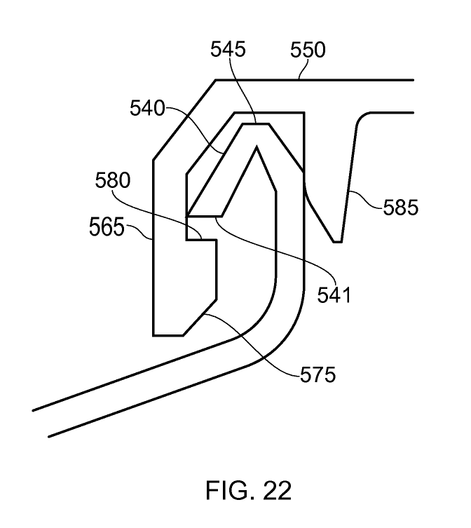

FIG. 22 is a section of the closure/neck of FIGS. 20 and 21.

Referring first to FIG. 1 there is shown a closure generally indicated 10 shown connected to a container generally indicated 15.

The closure 10 comprises a base 11 with a central dispensing orifice 12 for dispensing product from the container 15. The base 11 is connected to a lid 13 by a hinge 14. The lid is much larger (in plan) than the base.

The shoulder region 16 of container is almost horizontal and this presents a technical problem when receiving a closure because it is less capable of supporting capping forces than a more conical shoulder.

Closures such as this need to be received on a container neck and strongly retained, in other words it is not meant to be removed under normal circumstances. This presents conflicting requirements because in known closures the stronger the retention once the closure is in position the greater the capping force usually is to apply it.

One alternative would be to strengthen the bottle, for example by increasing the thickness of the shoulder and neck region. However, this is not preferable because this would require an increased amount of material.

Therefore, the present invention is based on the desire for a closure which is very easy to apply (in other words has a low capping force) but thereafter becomes extremely difficult to remove under normal circumstances. Having overcome this technical problem, of course, the principle can be used in a variety of circumstances to achieve low capping force with strong retention. Therefore the present invention is not limited in any way to closures of the type shown in FIG. 1, but rather any closure in which a base or base-like structure needs to be strongly retained on a container neck.

Referring now to FIGS. 2 to 4 there is shown a closure base generally indicated 20 formed in accordance with the present invention and shown fitted to a container neck generally indicated 25.

The base 20 comprises a generally circular top plate 30 and a generally cylindrical sidewall 35 which depends from the periphery of the top plate 30.

The top plate 30 has a central dispensing orifice 40 through which product from an associated container can be dispensed.

At the periphery of the top plate 30 a pair of arcuate slots 45, 50 are provided, one wall of which is defined by the sidewall 35. In this embodiment there are two slots which are provided diametrically opposite each other and extend approximately one third of the way around the top plate 30. In other embodiments different numbers (one or more) of slots which extend to a greater or lesser extent around the top plate may be provided.

At the end of the sidewall 35 opposite the top plate 30 a pair of arcuate retention projections 55 (only one is shown in FIG. 4) are provided. The projections 55 are in line with and of the same circumferential extent as the slots 44, 50. The projections 55 are generally wedge-shape, having an inclined face 56 and a flat retention face 57. In this embodiment the projections 55 are formed right at the free end of the sidewall 35. In other embodiments (not shown) the projections may be formed part way up the sidewall.

An annular sealing projection 31 depends from the underside of the top plate 30, radially inwardly of the sidewall 35.

In order to be complimentary with the base, the container neck 25 includes an annular retention bead 60. The bead 60 concludes an inclined face 61 and an undercut, flat face 62.

In use, the base 20 is applied to the neck 25 in a generally axial direction illustrated by arrow A in FIG. 4. As the base is pushed onto the neck the inclined face 56 of the projections 55 wilt start to engage and pass over the inclined face 61 of the bead 60. At this point the sidewall 35 will begin to flex outwardly by virtue of the notches 36. Subsequently the projections 55 will snap under the bead 60 so that the face 57 will become engaged under the face 62. The inter-engagement of the flat faces 57, 62 provide an extremely strong resistance to removal of the base from the container neck.

The projection 31 is received within the bore of the neck and the neck is received between the projection 31 and the wall 35.

It will be noted that, other than the notches 36, the sidewall is completely intact and solid. Referring now also to FIGS. 5 and 6 the method by which a closure of the type shown in FIGS. 2 to 4 can be manufactured with such a sharp top surface to a clip bead is described.

Referring first to FIG. 5 the part of a closure base in the region of the free end of a sidewall 135 including a projection 155 is illustrated. The projection 155 comprises an inclined face 156 and a flat retention face 157 joined by an axial face 158. The face 157 extends generally orthogonal to the sidewall 135 and therefore to the main cap axis A-A. In order for the face 157 to be moulded and de-moulded a die component 170 is introduced from above. Following moulding, the de-moulding process involves withdrawing the component 170 in a direction B axially away from the free end of the sidewall 135. This requires the withdrawal of the component 170 through the opposite end of the base. For this reason slots of the type described in relation to FIGS. 2 to 4 may be provided or other similar structures which would allow such a demoulding process.

Referring now to FIG. 6 there is shown a projection 255 formed according to an alternative embodiment. The demoulding principle bringing the tooling in and out “from the top” is the same as described in relation to FIG. 5. The projection 255 is similar to the projection 155 except that the top surface comprises a flat face part 257 and an inclined face part 259, giving, a reverse taper or hook-like structure with the component 270 correspondingly shaped.

Referring now to FIG. 7 there is shown a closure base generally indicated 320. In this embodiment the base 320 is shown by itself. However, in other embodiments the base forms part of a larger closure arrangement, for example including a lid, spout, hinge and the like.

The base 320 comprises a generally cylindrical sidewall 325 closed at one end by a top plate 330 which carries a central dispensing outlet 335.

At the end of the sidewall 25 opposite the top plate 330 a retention band 340 is provided. The band 340 is held securely on the sidewall 325 and is spaced therefrom by a gap 345.

In this embodiment the band 340 is provided as two arcuate band sections 341, 342. One end of each of the sections 341, 342 is connected to a respective leg 351, 352 of a generally inverted U-shape connector 350. The other end of each section 341, 342 is connected to a generally rectangular connection strap (referenced 355, see FIG. 9).

The connectors 350, 355 hold the sections 341, 342 firmly in the spaced relationship with the sidewall 325. The U-shape form of the connector allows for a degree of radially outward flexing of the sections 341, 342 as described in more detail below.

In use of the base 320 it is presented to a container neck as shown in FIGS. 8 to 11.

The container neck 360 includes a retention bead 365. As shown best in FIGS. 8 and 9, the bead 365 is formed as two bead sections 366, 367 separated by diametrically opposed recesses 368, 369 which accommodate the connectors 350, 355.

The section of the bead 365 is shown best in FIGS. 10 and 11 and is shown to comprise a sloping upper surface 370 and an oppositely inclined, undercut lower surface 375.

An annular sealing projection 380 depends from the top plate 330 radially inwardly of the wall 325. When the base 320 is pushed onto the neck the projection fits sealingly with the neck bore.

In use, the base 320 is applied to the neck 360 by a generally axial, downward (as shown in the drawings) capping force. This causes the lower edge 343 of the band 340 to contact the sloping surface 371. As the base 320 is pushed down the band sections 341, 342 are caused to flex outwardly by the sloping surface 370 and then the sections 341, 342 will flex back in to the position shown in FIGS. 10 and 11 in which the sections 341, 342 are engaged under the surface 375.

As shown best in FIG. 11, the section of the band sections 341, 342 includes a tapered part 344 opposite the end 343. This reduced thickness provides a particularly strong and stable abutment with the surface 375.

With the base 320 engaged as shown in FIGS. 8 to 11 removal is made extremely difficult by the engagement of the sections 341, 342 under the projections 366, 367.

In some embodiments the closure is manufactured by a moulding process in which the manufacture is all in the line of draw, with the band/ring being bumped out of the mould.

Referring now to FIG. 12 there is shown a closure base 420 formed according to the present invention and shown fitted to a container neck 425.

The base 420 comprises a circular top plate 430 with a central dispensing orifice 435. A generally cylindrical sidewall 440 depends from the periphery of the plate 430.

Referring now to FIG. 13 the base 420 is shown removed from the container neck and in an as-moulded, first position. The free end of the sidewall 440 is shown to comprise an annular retention flap 445. The flap 445 is joined to the free end of the sidewall 440 by a hinge line 450 and is inclined radially inwardly.

The flap 445 is movable from the position shown in FIG. 13 to the position shown in FIG. 14 in which it has been folded up inside the sidewall 440.

The folding operation of the flap 440 is illustrated in FIG. 15 in which both the unfolded and folded positions of the flap are illustrated.

An annular sealing plug 455 depends from the underside of the top plate 30 radially inwardly of the sidewall 440.

The container neck 425 comprises a generally cylindrical neck finish 426 with a clip retention bead 427 formed on its exterior surface. The bead 427 comprises an inclined face 28 and an undercut, retention face 429.

In use, the base 420 is applied to the neck 425 from above. Initially the base 420 is in the position shown in FIG. 13, with the flap 440 downwardly extending. As the closure base 420 is applied the flap 440 contacts the inclined face 428 and begins to be folded. Ultimately the flap 445 becomes fully folded and passes under the projection 427 so that the free end of the now upturned flap 445 engages under the retention surface 429. The plug 455 fits within the bore of the finish 426 and the neck is received between the plug 455 and the sidewall 440.

In this position the upturned flap 445 is firmly engaged under the surface 429 and cannot be unfolded so that the base 420 is securely retained on the neck 425.

Referring now to FIG. 17, there is shown the neck region of a container generally indicated 520. The container shoulder 525 supports a generally tubular neck finish 530. The finish 530 comprises a tubular mouth 535 which at its end opposite the shoulder 525 includes a terminal rim 540. The rim 540 is formed as a generally outwardly flared band joined to the mouth 535 at a hinge line 545.

The rim 540 is moveable from the position shown in FIG. 17 to the position shown in FIG. 18. In this position, the rim 540 has been folded along the line 545 from the “upwardly” flared configuration in FIG. 17 to the “downwardly” flared position shown.

The folding movement of the rim 540 is also shown in FIG. 19, in which it can be seen that the rim 540 folds down towards the exterior of the mouth 535. An inverted V- or U-shape is formed at the mouth opening. The rim 540 does not fold flat against the mouth.

Referring now also to FIGS. 20 to 22, the neck finish 530 is shown fitted with a closure base 550. The closure 550 comprises a generally circular top plate 555 with a central dispensing orifice 560. A generally cylindrical side wall 565 depends from the periphery of the plate 550. At the free end of the side wall 565 a retaining projection 570 is provided. The projection 570 comprises an inclined face 575 and a retention face 580.

An annular sealing plug 585 depends from the underside of the top plate 550 radially inwardly of the side wall 565.

In use, the base 550 is presented to the neck 530 and pushed down from above. The inclined projection face 575 will contact the rim 540, which initially is in the position shown in FIG. 17.

Continued axially movement of the base then causes the rim 540 to be folded down by the projection 570 to the position shown in FIGS. 20 and 22. In this position, the rim 540 is retained in its folded configuration between the side wall 535 and the plug 585. The top 541 of the rim 540 is then adjacent to (and may contact) the retention face 580 of the projection 570. The rim 540 is then effectively trapped in the closure and will resist removal of the base. This is because the rim cannot now be folded back to the first position along the fold line 545 because of the dimensional constraints placed upon it by the interior of the closure. In other words, the closure blocks unfolding of the rim/flap, and effectively the rim is locked in the second position.

The rim 540 is rigid enough to resist bending along its length so that the rim is constrained to move only by bending along the line 545.

Relative to the main axis of the container neck, the rim moves from a 45° ‘upward’ position to a 45° ‘downward’ position in a 90° ‘elbow’-like configuration. In this embodiment the rim is moulded in the unfolded, upward inclination and movable to the folded, downward inclination either by the application of a closure or in a separate, pre-folding step prior to application of a closure.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1-49. (canceled)

50. A moulded closure base for providing at least part of a container closure, the base including a sidewall and a top plate, the sidewall having a retention projection having a retention surface for engaging a complementary projection on a container neck, the top plate having one or more access slots through which part of a die has extended into, and has been withdrawn from, during moulding to form the retention surface.

51. The base as claimed in claim 50, in which the retention surface is generally straight.

52. The base as claimed in claim 50, in which at least part of the retention surface extends at an angle of approximately 90° with respect to a main axis of the base.

53. The base as claimed in claim 50, in which at least part of the retention surface extends at an angle of less than 90° with respect to a main axis of the base.

54. The base as claimed in claim 50, in which the base includes a dispensing orifice.

55. The base as claimed in claim 50, in which the retention projection is continuous.

56. The base as claimed in claim 50, in which the retention projection is discontinuous.

57. The base as claimed in claim 50, in which the sidewall includes a tamper-evident band.

58. The base as claimed in claim 57, in which the retention projection is formed on the tamper-evident band.

59. The base as claimed in claim 50, in which the base is non-removable.

60. The base as claimed in claim 50, in which each slot is arcuate.

61. The base as claimed in claim 50, in which the base includes one or more respective retention projections which is/are in line with one or more respective access slots.

62. The base as claimed in claim 50, in which the top plate has a pair of diametrically opposed arcuate access slots.

63. The base as claimed in claim 50, in which the base includes an annular sealing projection which depends from the underside of the top plate and is radially inward of the sidewall.

64. A container closure comprising a base as claimed in claim 50.

65. The closure as claimed in claim 64, in which the closure further comprises a lid.

66. A method of forming a closure base, comprising:
moulding a body including a sidewall and a top plate; and
moulding a retention projection on the sidewall;
in which the tooling for moulding at least part of the retention projection is introduced through the top plate.

67. A method of moulding a closure base comprising the steps of:
moulding a body including a sidewall and a top plate, the sidewall including one or more retention projections;
introducing a die component through a mould cavity space which will form part of the top plate as part of step (a);
moulding the body; and
withdrawing the die component through one or more slots which have been formed in the top plate by the die component, such that the body retains the slot(s) after being demoulded.

68. The method as claimed in claim 67, in which the retention projection includes a retention surface and the die component forms the retention surface.

69. The method as claimed in claim 67, in which the die component is introduced from above.
